(19) United States
(12) Patent Application Publication
(10) Pub. No.: US 2023/0392027 A1
(43) Pub. Date: Dec. 7, 2023

(54) ABRASION-RESISTANT THERMOFORMABLE COATING AND PREPARATION OF SAME

(71) Applicant: 3M INNOVATIVE PROPERTIES COMPANY, St. Paul, MN (US)

(72) Inventors: Benjamin R. Coonce, South St. Paul, MN (US); Matthew Burch, Woodbury, MN (US); John C. Clark, Lake Elmo, MN (US); Richard J. Pokorny, Maplewood, MN (US); Benjamin G. Sonnek, Mahtomedi, MN (US)

(21) Appl. No.: 18/204,835

(22) Filed: Jun. 1, 2023

Related U.S. Application Data
(60) Provisional application No. 63/352,900, filed on Jun. 16, 2022.
(60) Provisional application No. 63/349,417, filed on Jun. 6, 2022.

(51) Int. Cl. C09D 7/62; C09D 7/40; C09D 4/00; C09D 133/04

(52) U.S. Cl. CPC C09D 7/62; C09D 7/67; C09D 7/68; C09D 4/00; C09D 133/04

(57) ABSTRACT

Coating compositions including a nanoparticle layer including nanoparticles and a curable resin and a curable resin layer comprising the curable resin, where the nanoparticle layer has a thickness of 0.2 μm to 8 μm, and where the nanoparticle layer includes less than 40 vol. % of the curable resin. Methods for preparing the coating compositions, laminates including the coating compositions, and articles including the laminates are provided.

### TECHNICAL FIELD The present disclosure generally relates to abrasion-resistant coatings including nanoparticles and methods of preparing such coatings.

### BACKGROUND

A hardcoat can be useful as a protective layer on a substrate, particularly when the substrate may be exposed to physical wear and/or extreme weather conditions. For example, hardcoats have been used to protect the face of optical displays. Such hardcoats typically contain inorganic oxide particles, e.g., silica, of nanometer dimensions dispersed in a binder precursor resin matrix, and are described, for example, in U.S. Pat. No. 9,377,563 (Hao et al.).

### SUMMARY

In one aspect, provided herein are coating compositions including a nanoparticle layer including nanoparticles and a curable resin and a curable resin layer comprising the curable resin, where the nanoparticle layer has a thickness of 0.2 μm to 8 μm, and where the nanoparticle layer includes less than 40 vol. % of the curable resin.

In another aspect, provided herein are laminates including the disclosed coating compositions and articles including such laminates.

In another aspect, provided herein are methods of coating a substrate with the disclosed coating compositions.

As used herein,

The terms “cure” and “curing” refer to processes through which a material hardens and/or becomes solid. Curing can include processes such as, for example, polymerization, crosslinking, drying, cooling from melt, electrolyte complexation, and combinations thereof.

The term “alkyl” refers to a monovalent group which is a saturated hydrocarbon. The alkyl can be linear, branched, cyclic, or combinations thereof and typically has 1 to 30 carbon atoms. In some embodiments, the alkyl group contains 1 to 30, 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and 2-ethylhexyl.

The term “(meth)acrylate” refers to an acrylate, a methacrylate, or both.

The term “aspect ratio” refers to the ratio between the length (i.e., longest dimension) and the width (i.e., the shortest dimension) or the diameter of a particle.

The term “precursor” refers to a constituent part or reactant which, when reacted, cured, and/or polymerized will form a hardened material. A precursor may include a monomer and/or an oligomer.

Features and advantages of the present disclosure will be further understood upon consideration of the detailed description as well as the appended claims.

### BRIEF DESCRIPTION OF THE DRAWINGS

FIG. 1 is a schematic cross-sectional view of an exemplary article of the present disclosure.

FIG. 2 is a schematic representation of a method for preparing an article according to some embodiments of the present disclosure.

FIG. 3A is an image of silica nanoparticles dispersed in isopropanol, 10 to 15 nm particle size, supplied at 30% solids from Nissan Chemical America Corporation.

FIG. 3B is an image of silica nanoparticles dispersed in isopropanol, 40 to 50 nm particle size, supplied at 30% solids from Nissan Chemical America Corporation.

FIG. 3C is an image of silica nanoparticles dispersed in isopropanol, 9 to 15 nm particle strand diameter and 40 to 100 nm overall length, supplied at 15% solids from Nissan Chemical America Corporation.

FIG. 4 is a scanning electron microscopy (“SEM”) image of a cross-section of an article according to the present disclosure.

FIG. 5 is an SEM image of a cross-section of the top layer (i.e., the nanoparticle layer) of the article of FIG. 4.

FIG. 6 is a schematic representation of an apparatus for preparing a laminate article according to some embodiments of the present disclosure.

FIG. 7 is a schematic representation of steps for preparing a lens including a thermoformed laminate of the present disclosure.

FIG. 8A is a top view of a thermoforming mold useful in some embodiments of the present disclosure.

FIG. 8B is a section view of the thermoforming mold of FIG. 8A.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

To achieve a desired abrasion resistance effect, hardcoat formulations can commonly include up to 40 wt. % of a filler, such as, for example, nano-silica particles. However, an abundance of filler particles in the hardcoat bulk may be undesirable in some circumstances. For example, hardcoats including an abundance of filler particles distributed throughout the hardcoat bulk, particularly when used outdoors, tend to suffer embrittlement and hazing issues, i.e., weathering, due to the amount of nano-silica present in the hardcoat resin formulations. Furthermore, hardcoats including an abundance of filler particles distributed throughout the hardcoat bulk are often unsuitable for use in thermoforming processes due to the rigidity imparted to the coating by the addition of the nano-silica particles, rigidity which can lead to formation of defects, e.g., cracks, hazing, in the thermoformed product.

By constructing the hardcoat according to the present disclosure, the total amount of nano-silica filler required in the formulation can be reduced by forcing the filler to concentrate at the coating surface where it may be most effective at retarding abrasion. It has been surprisingly discovered that such coatings exhibit superior abrasion resistance when compared to coatings including silica nanoparticles dispersed throughout the thickness of the coating layer while maintaining sufficient flexibility for use in thermoforming processes. This reduced level of nano-silica in the hardcoat may also have a positive impact on the resistance to outdoor weathering of the product.

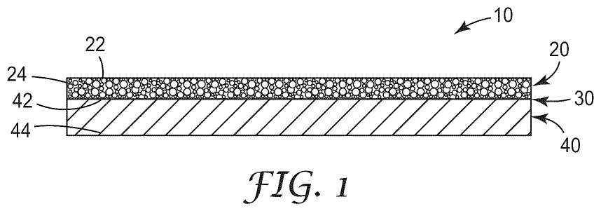

Provided herein are coating compositions including a nanoparticle layer including nanoparticles and a curable resin and a curable resin layer comprising the curable resin, where the nanoparticle layer has a thickness of 0.2 μm to 8 μm, and where the nanoparticle layer includes less than 40 vol. % of the curable resin. FIG. 1 shows a cross-sectional view of an exemplary coating composition 10 prepared according to some embodiments of methods of the present disclosure. As shown in FIG. 1, coating composition 10 includes a nanoparticle layer 20 having a first major surface 22 and an opposing second major surface 24 and a curable resin layer 40 having a first major surface 42 and a second opposing major surface 44. The nanoparticle layer 20 and the curable resin layer 40 are adjacent each other at interface 30.

Provided herein are laminates including the coating composition and a substrate, where the substrate is adjacent to the curable resin layer. Also provided herein are articles including the laminates.

### Nanoparticle Layer

The nanoparticle layer may include particles comprising, for example, silica, alumina, ceria, diamond, titanium dioxide, zinc oxide, tungsten oxide, zirconia, calcium carbonate, magnesium silicate, indium tin oxide, antimony tin oxide, tungsten bronze, and combinations thereof. The nanoparticle layer may be formed by methods known to those of ordinary skill in the art, for example, by applying silica nanoparticles dispersed in a solvent (e.g., isopropanol) onto a disposable liner material (e.g., polypropylene) and allowing the solvent to evaporate from the nanoparticle layer.

A variety of materials are suitable for use as the liner material, including both flexible materials and materials that are more rigid. Due to their ability to facilitate separation of the coating composition from the liner material, flexible materials may be preferred. The liner may include, for example, a polymeric film, a primed polymeric film, a metal foil, a cloth (e.g., a textile), a paper, a vulcanized fiber, a nonwoven material and treated versions thereof, and combinations thereof. In some embodiments, the liner is non-porous. In some embodiments the liner may include, for example, a material selected from the group consisting of a silicon, a glass, a metal, a metal oxide, a polymeric film, and combinations thereof. In some embodiments, for example, where the curable resin is designed to be polymerized, i.e., cured, by actinic radiation, or when greater flexibility is desired, the liner may be a polymeric film or treated polymeric film. Examples of such films include, but are not limited to, polyester film (e.g., polyethylene terephthalate film, polybutylene terephthalate film, polybutylene succinate film, polylactic acid film), co-polyester film, polyimide film, polyamide film, polyurethane film, polycarbonate film, polyvinyl chloride film, polyvinyl alcohol film, polypropylene film (e.g., biaxially oriented polypropylene), polyethylene film, poly(methyl methacrylate) film, and the like. In some embodiments, the film layer may be biodegradable film, e.g. polybutylene succinate film, polylactic acid film. In some embodiments laminates of different polymer films may be used to form the liner. In embodiments wherein curable resin is designed to be polymerized, i.e. cured, by actinic radiation, the disposable liner may allow for sufficient transmission of the actinic radiation to enable polymerization. In some embodiments, the liner has a percent transmission of at least 50 percent, at least 60 percent, at least 70 percent, at least 80 percent, at least 90 percent or at least 95 percent over at least a portion of the UV/Visible light spectrum. In some embodiments, the liner has a percent transmission of at least 50 percent, at least 60 percent, at least 70 percent, at least 80 percent, at least 90 percent or at least 95 percent over at least a portion of the visible light spectrum (about 400 to 700 nm). The percent transmission may be measured by conventional techniques and equipment, such as using a HAZEGARD PLUS haze meter from BYK-Gardner Inc., Silver Springs, Maryland, to measure the percent transmission of a film layer having an average thickness of from 1 to 100 micrometers. In some embodiments, the thickness of the film layer may be 1 to 1,000 micrometers, 1 to 500 micrometers, 1 to 200 micrometers, or 1 to 100 micrometers. In some embodiments, the liner may include an antistatic material or the liner may include an antistatic coating on one or both of its major surfaces.

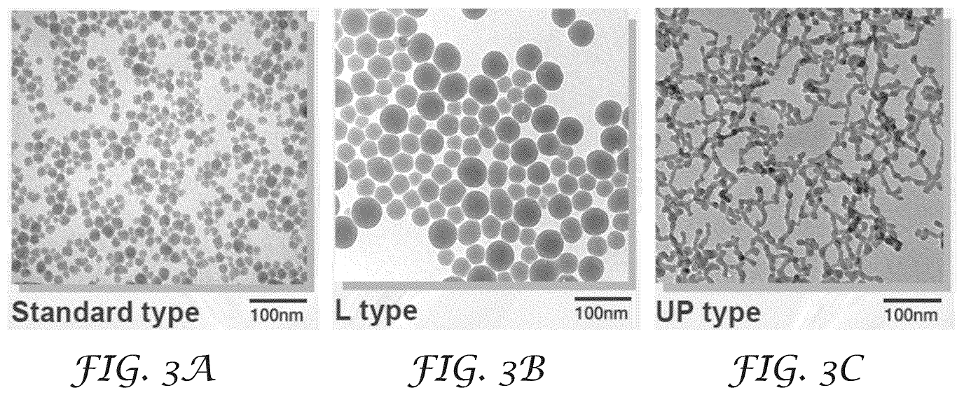

In some preferred embodiments, the particles of the nanoparticle layer may be of a uniform size and shape such as, for example, a spherical shape having an average diameter of 1 nm to 100 nm (e.g., 20 nm), optionally 1 nm to 400 nm, optionally 2 nm to 200 nm, or optionally 5 nm to 100 nm. In some embodiments, the particles of the nanoparticle layer may be of an irregular shape, i.e., the particles may have an aspect ratio greater than 1:1, e.g., or a mixture of regular and/or irregular shapes. In some preferred embodiments, the nanoparticles may have an aspect ratio of 2:1 to 12:1, optionally 3:1 to 11:1, optionally 4:1 to 10:1, or optionally 5:1 to 9:1. In some preferred embodiments, the nanoparticles comprise an elongated silica nanoparticle having a diameter of 9 nm to 15 nm and a length of 40 nm to 100 nm. Examples of nanoparticles useful in embodiments of the present disclosure are shown, for example, in FIGS. 3A-3C. In some embodiments, the nanoparticles may be coated with another material, such as, for example, a silane coating as described in U.S. Pat. Pub. 2015/0017386 A1 (Kolb et al.).

The nanoparticle layer commonly has a thickness of thickness of 0.2 μm to 8 μm, optionally 0.4 μm to 6 μm, optionally 0.8 μm to 4 μm, or optionally 1 μm to 3 μm and comprises less than 40 vol. %, less than 30 vol. %, less than 20 vol. %, less than 10 vol. %, less than 5 vol. %, or less than 1 vol. % of the curable resin that has interpenetrated the nanoparticle layer from the curable resin layer during formation of the coating composition. Though not wishing to be bound by a particular theory, it is believed that the curable resin may be drawn through interstices of the nanoparticle layer structure into the thickness of the nanoparticle layer by a process such as, for example, capillary action when the nanoparticle layer is contacted with the curable resin during formation of the coating composition. In preferred embodiments, the opposing major surfaces of the nanoparticle layer are planar and flat, i.e., the major surfaces do not generally include structures (e.g., nanostructures) extending from or carved into the major surfaces.

### Curable Resin

The composition of the curable resin is not particularly limited. The curable resin is capable of being cured and the curing technique is not particularly limited and may include, for example, curing by actinic radiation, thermal curing, e-beam curing and combinations thereof. Actinic radiation may include electromagnetic radiation in the UV, e.g. 100 to 400 nm, and visible range, e.g. 400 to 700 nm, of the electromagnetic radiation spectrum. Due to its rapid cure characteristics, the curing of the curable resin by actinic radiation may be preferred. The curable resin may include monomers, oligomers and/or polymers that can be cured by conventional free-radical mechanisms.

In some embodiments, the curable resin includes one or more (meth)acrylates. The (meth)acrylate may be at least one of monomeric, oligomeric and polymeric. The (meth)acrylate may be polar, non-polar or mixtures thereof. Non-polar (meth)acrylate may include alkyl meth(acrylate). Useful non-polar (meth)acrylate include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, iso-pentyl (meth)acrylate (i.e., iso-amyl (meth)acrylate), 3-pentyl (meth)acrylate, 2-methyl-1-butyl (meth)acrylate, 3-methyl-1-butyl (meth)acrylate, stearyl (meth)acrylate, phenyl (meth)acrylate, n-hexyl (meth)acrylate, iso-hexyl (meth)acrylate, cyclohexyl (meth)acrylate, 2-methyl-1-pentyl (meth)acrylate, 3-methyl-1-pentyl (meth)acrylate, 4-methyl-2-pentyl (meth)acrylate, 2-ethyl-1-butyl (meth)acrylate, 2-methy-l-hexyl(meth)acrylate, 3,5,5-trimethyl-1-hexyl (meth)acrylate, cyclohexyl (meth)acrylate, 3-heptyl (meth)acrylate, benzyl (meth)acrylate, n-octyl (meth)acrylate, iso-octyl (meth)acrylate, 2-octyl (meth)acrylate, 2-ethyl-1-hexyl (meth)acrylate, n-decyl (meth)acrylate, iso-decyl (meth)acrylate, isobornyl (meth)acrylate, 2-propylheptyl (meth)acrylate, isononyl (meth)acrylate, isophoryl (meth)acrylate, n-dodecyl (meth)acrylate (i.e., lauryl (meth)acrylate), n-tridecyl (meth)acrylate, iso-tridecyl (meth)acrylate, 3,7-dimethyl-octyl (meth)acrylate, and any combinations or mixtures thereof. Combinations of non-polar (meth)acrylates may be used.

Polar (meth)acrylates include, but are not limited to, 2-hydroxyethyl (meth)acrylate; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate; alkoxylated (meth)acrylates (e.g. ethoxylated and propoxylated (meth)acrylate), and mixtures thereof. The alkoxylated (meth)acrylates may be monofunctional, difunctional, trifunctional or have higher functionality. Ethoxylated acrylates include, but are not limited to, ethoxylated (3) trimethylolpropane triacrylate (available under the trade designation “SR454”, from Sartomer, Exton, Pennsylvania), ethoxylated (6) trimethylolpropane triacrylate (available under the trade designation “SR499”, from Sartomer), ethoxylated (6) trimethylolpropane triacrylate (available under the trade designation “MIRAMER M3160” from Miwon North America Inc., Exton

Pennsylvania), ethoxylated (9) trimethylolpropane triacrylate (available under the trade designation “SR502”, from Sartomer), ethoxylated (15) trimethylolpropane triacrylate (available under the trade designation “SR9035”, from Sartomer), ethoxylated (20) trimethylolpropane triacrylate (available under the trade designation “SR415”, from Sartomer), polyethylene glycol (600) diacrylate (available under the trade designation “SR610”, from Sartomer), polyethylene glycol (400) diacrylate (available under the trade designation “SR344”, from Sartomer), polyethylene glycol (200) diacrylate (available under the trade designation “SR259”, from Sartomer), ethoxylated (3) bisphenol A diacrylate (available under the trade designation “SR349”, from Sartomer), ethoxylated (4) bisphenol A diacrylate (available under the trade designation “SR601”, from Sartomer), ethoxylated (10) bisphenol A diacrylate (available under the trade designation “SR602”, from Sartomer), ethoxylated (30) bisphenol A diacrylate (available under the trade designation “SR9038”, from Sartomer), propoxylated neopentyl glycol diacrylate (available under the trade designation “SR9003”, from Sartomer), polyethylene glycol dimethacrylate (available under the trade designation “SR210A”, from Sartomer), polyethylene glycol (600) dimethacrylate (available under the trade designation “SR252”, from Sartomer), polyethylene glycol (400) dimethacrylate (available under the trade designation “SR603”, from Sartomer), ethoxylated (30) bisphenol A dimethacrylate (available under the trade designation “SR9036”, from Sartomer. Combinations of polar (meth)acrylates may be used.

Other monomers that may be used and considered to be in the category of polar (meth)acrylates include N-vinylpyrrolidone; N-vinylcaprolactam; acrylamides; mono- or di-N-alkyl substituted acrylamide; t-butyl acrylamide; dimethylaminoethyl acrylamide; N-octyl acrylamide and; acrylic acid, and methacrylic acid, and alkyl vinyl ethers, including vinyl methyl ether.

In some embodiments, the curable resin includes a precursor, such as, for example a polyurethane precursor, an epoxy precursor (typically an epoxide and hardener), a polyurea precursor, or combinations thereof.

In some embodiments, the curable resin includes a crosslinker. The crosslinker often increases the cohesive strength and the tensile strength of the cured adhesive layer. The crosslinker can have at least two functional groups, e.g., two ethylenically unsaturated groups, which are capable of polymerizing with other components of the curable resin. Suitable crosslinkers may have multiple (meth)acryloyl groups. Alternatively, the crosslinker can have at least two groups that are capable of reacting with various functional groups (i.e., functional groups that are not ethylenically unsaturated groups) on another monomer. For example, the crosslinker can have multiple groups that can react with functional groups such as acidic groups on other monomers.

Crosslinkers with multiple (meth)acryloyl groups can be di(meth)acrylates, tri(meth)acrylates, tetra(meth)acrylates, penta(meth)acrylates, and the like. In many aspects, the crosslinkers contain at least two (meth)acryloyl groups. Exemplary crosslinkers with two acryloyl groups include, but are not limited to, 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary crosslinkers with three or four (meth)acryloyl groups include, but are not limited to, trimethylolpropane triacrylate (available under the trade designation “TMPTA-N” from Cytec Industries, Inc., Smyrna, Ga. and under the trade designation “SR351” from Sartomer), pentaerythritol triacrylate (available under the trade designation “SR444” from Sartomer), tris(2-hydroxyethylisocyanurate) triacrylate (available under the trade designation “SR368” from Sartomer), a mixture of pentaerythritol triacrylate and pentaerythritol tetraacrylate (available under the trade designation “PETIA” with an approximately 1:1 ratio of tetraacrylate to triacrylate and under the trade designation “PETA-K” with an approximately 3:1 ratio of tetraacrylate to triacrylate, from Cytec Industries, Inc.), pentaerythritol tetraacrylate (available under the trade designation “SR295” from Sartomer”), di-trimethylolpropane tetraacrylate (available under the trade designation “SR355” from Sartomer), and ethoxylated pentaerythritol tetraacrylate (available under the trade designation “SR494” from Sartomer). An exemplary crosslinker with five (meth)acryloyl groups includes, but is not limited to, dipentaerythritol pentaacrylate (available under the trade designation “SR399” from Sartomer). Previously mentioned multifunctional polar (meth)acrylate may be considered crosslinkers.

In some aspects, the crosslinkers are polymeric materials that contain at least two (meth)acryloyl groups. For example, the crosslinkers can be poly(alkylene oxides) with at least two acryloyl groups (polyethylene glycol diacrylates commercially available from Sartomer under the trade designation “SR210”, “SR252”, and “SR603”, for example). The crosslinkers poly(urethanes) with at least two (meth)acryloyl groups (polyurethane diacrylates such as CN9018 from Sartomer). As the higher molecular weight of the crosslinkers increases, the resulting acrylic copolymer tends to have a higher elongation before breaking. Polymeric crosslinkers tend to be used in greater weight percent amounts compared to their non-polymeric counterparts.

Other types of crosslinkers can be used rather than those having at least two (meth)acryloyl groups. The crosslinker can have multiple groups that react with functional groups such as acidic groups on other monomers. For example, monomers with multiple aziridinyl groups can be used that are reactive with carboxyl groups. For example, the crosslinkers can be a bis-amide crosslinker as described in U.S. Pat. No. 6,777,079 (Zhou et al.).

The amount of crosslinker in the curable resin is not particularly limited and depends on the desired final properties of the cured adhesive layer formed therefrom. Crosslinking may improve the cohesive strength of the cured adhesive layer and facilitate removal from the surface of the substrate without leaving residue while improving the ability of the cured adhesive layer to entrap the particulate contaminant and remove it from the substrate surface. In some embodiments the curable resin may include at least 5 percent, at least 10 percent, at least 30 percent, at least 40 percent, at least 50 percent, at least 60 percent at least 70 percent, at least 80 percent, at least 90 percent, at least 95 percent or at least 97 percent by weight of crosslinker. In some embodiments the curable resin may include at least 5 percent at least 10 percent, at least 20 percent, at least 30 percent and/or less than 100 percent, less than 99 percent, less than 97 percent, less than 95 percent, less than 90 percent, less than 85 percent by weight of crosslinker. In some embodiments the curable resin may include from between 50 and 100 percent, between and 100 percent, between 70 and 100 percent, between 80 and 100 percent, between 90 and 100 percent, between 50 and 98 percent, between 60 and 98 percent, between 70 and 98 percent, between 80 and 98 percent, between 90 and 98 percent, between 50 and 95 percent, between 60 and 95 percent, between 70 and 95 percent, between 80 and 95 percent, between 90 and 95 percent by weight of the crosslinker. In some embodiments, the crosslinker is a polar meth(acrylate).

In some embodiments, the curable resin comprises a (meth)acrylate resin, a polyurethane precursor, an epoxy precursor (epoxide and hardener), a polyurea precursor, a cyanoacrylate resin, a polyester (meth)acrylate resin, a polyurethane (meth)acrylate resin, and combinations thereof. In some preferred embodiments the curable resin comprises a (meth)acrylate resin.

### Additives

In some embodiments, the curable resin further comprises 0.1 wt. % to 10 wt .% of a photoinitiator. Photinitiators, may be added to the curable resin to facilitate polymerization of the curable resin. The photoinitators are typically designed to be activated by the exposure to actinic radiation. Photoinitiators include, but are not limited to, those available under the trade designations “IRGACURE” and “DAROCUR” from BASF Corp, Florham Park, N.J., and include 1-hydroxy cyclohexyl phenyl ketone (trade designation “IRGACURE 184”), 2,2-dimethoxy-1,2-diphenylethan-1-one (trade designation “IRGACURE 651”), Bis(2,4,6-trimethyl benzoyl)phenylphosphineoxide (trade designation “IRGACURE 819”),1-[4-(2-hydroxyethoxy)phenyl]-2-hydroxy-2-methyl-1-propane-1-one (trade designation “IRGACURE 2959”), 2-benzyl-2-dimethylamino-1-(4-morpholinophenyl)butanone (trade designation “IRGACURE 369”), 2-methyl-1[4-(methylthio)phenyl]1-2-morpholinopropan-1-one (trade designation “IRGACURE 907”), and 2-hydroxy-2-methyl-1-phenyl propan-1-one (trade designation “DAROCUR 1173”).

Other additives may optionally be included in the curable resin and, subsequently, the coating. Additives include, but are not limited to nanoparticles dispersed throughout the curable resin, pigments, surfactants, solvents, wetting aids, slip agents, leveling agents, tackifiers, toughening agents, reinforcing agents, fire retardants, antioxidants, antistatic agents (e.g., trimethylacryloxyethyl ammonium bis(trifluoromethyl)sulfonimide), stabilizers, and combinations thereof. The additives are added in amounts sufficient to obtain the desired end properties. In some embodiments, the amount of additive in the curable resin is from 0.1 wt. % to wt. %, 0.1 wt. % to 20 wt. %, or 0.1 wt. % to 10 wt. %.

### Coating Composition

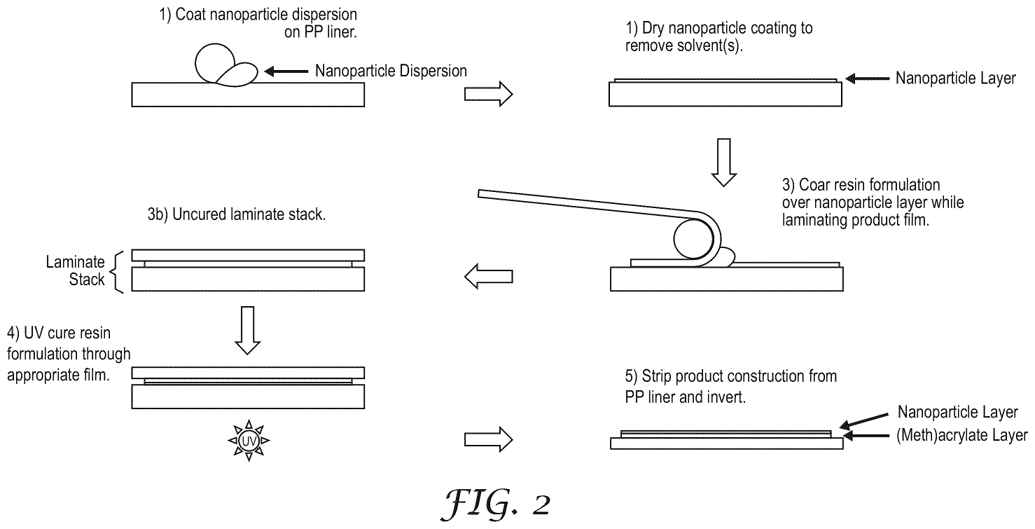

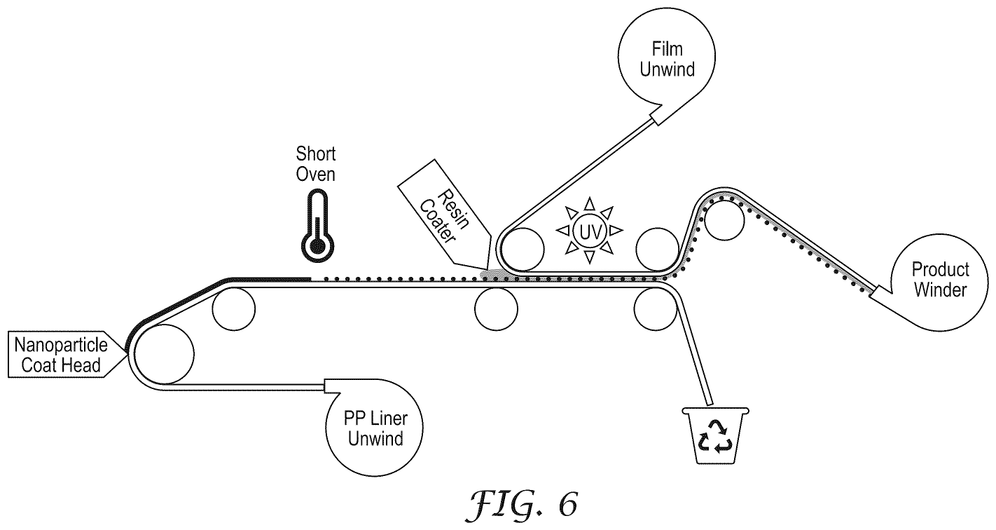

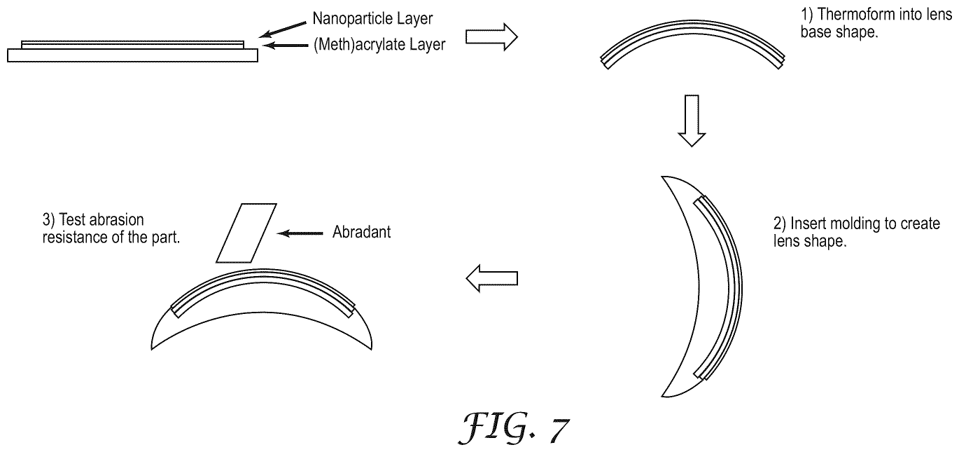

A coating composition of the present disclosure may be prepared by the methods known to those of ordinary skill in the relevant arts and using the materials described above. The methods disclosed in the Examples below and shown in FIG. 2 can be scaled for roll-to-roll processing by one of ordinary skill in the relevant arts as shown, for example, in FIG. 6. As shown in FIG. 6, the curable resin layer is typically contacted with a substrate before curing to provide a laminate. A variety of materials are suitable for use as the substrate, including both flexible materials and materials that are more rigid. The substrate may include, for example, a polymeric film, a primed polymeric film, a metal foil, a cloth (e.g., a textile), a paper, a vulcanized fiber, a nonwoven material and treated versions thereof, and combinations thereof. The substrate may be a polymeric film or treated polymeric film. Examples of such films include, but are not limited to, polyester film (e.g., polyethylene terephthalate film, polybutylene terephthalate film, polybutylene succinate film, polylactic acid film), co-polyester film, polyimide film, polyamide film, polyurethane film, polycarbonate film, polyvinyl chloride film, polyvinyl alcohol film, polypropylene film (e.g., biaxially oriented polypropylene), polyethylene film, poly(methyl methacrylate) film, and the like. In some preferred embodiments, the substrate is a polymeric film such as, for example, a polycarbonate film. As shown in FIG. 7, such laminates may undergo further processing such as, for example, thermoforming, and may be incorporated into articles such as, for example, lenses to provide abrasion resistance. Additional articles that may include the laminate include, but are not limited to, automotive interior fixtures and electronics cases. In preferred embodiments, hardcoats prepared according to methods of the present disclosure exhibit a delta haze less than 25, less than 10, less than 5, less than 2.5, or less than 2 according to ASTM D1044-13.

Objects and advantages of this disclosure are further illustrated by the following non-limiting examples, but the particular materials and amounts thereof recited in these examples, as well as other conditions and details, should not be construed to unduly limit this disclosure.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 1
Materials

| Abbreviation | Description and Source |
|---|---|
| SR420 | Trimethyl cyclohexyl acrylate from Sartomer, Exton, Pennsylvania, as SR420 |
| SR506 | Isobornyl acrylate available from Sartomer as SR506 |
| SR285 | Tetrahydrofurfuryl acrylate available from Sartomer as SR285 |
| SR9035 | Ethoxylated (15) trimethylolpropane triacrylate available from Sartomer as SR9035 |
| IRG819 | Bis (2,4,6-trimethylbenzoyl)-phenylphosphine oxide available from BASF |
| | Corporation, Florham Park, New Jersey, as IRGACURE 819 |
| PET1 | 2 mil (51 micron) polyethylene terephthalate film available from 3M Company, St. |
| | Paul, Minnesota, as SCOTCHPAK POLYESTER FILM |
| SR238 | 1,6 hexanediol diacrylate available from Sartomer as SR238 |
| SR295 | Pentaerythritol tetraacrylate available from Sartomer as SR295 |
| IRG184 | 1-hydroxycyclohexyl phenyl ketone available from BASF Corporation as |
| | IRGACURE 184 |
| IRGTPO | 2,4,6-trimethylbenzoyl-diphenyl phosphine oxide available from BASF Corporation |
| | as IRGACURE TPO |
| NBYK3605 | Dispersion of surface-treated silica nanoparticles in hexanediol diacrylate, 50% |
| | nanoparticle content, 20 nm particle size, available from BYK USA Incorporated, |
| | Wallingford, Connecticut, as NANOBYK-3605 |
| PC1 | 5 mil (127 micron) polycarbonate film available from Sabic Americas Inc., Houston, |
| | Texas, as LEXAN 8010-112MC |
| EB4513 | Trifunctional urethane acrylate oligomer available from Allnex, Alpharetta, Georgia, |
| | as EBECRYL 4513 |
| CN991 | Difunctional urethane acrylate oligomer available from Sartomer as CN991 |
| ESACURE | Difunctional alpha hydroxy ketone available from IGM Resins, Charlotte, North |
| ONE | Carolina, as ESACURE ONE |
| PP1 | 2 mil (51 micron) polypropylene film available from Inteplast Group, Livingston, |
| | New Jersey, as VT60A |
| PP2 | 2 mil (51 micron) polypropylene film available from Inteplast Group, as TT50T |
| PP3 | 2 mil (51 micron) polypropylene film available from 3M Company, as the backing |
| | for SCOTCH Heavy Duty packaging tape (3850) |
| IPA-ST | Silica nanoparticles dispersed in isopropanol, 10-15 nm particle size. Supplied at 30% |
| | solids from Nissan Chemical America Corporation, Houston, Texas, as IPA-ST |
| IPA-ST-L | Silica nanoparticles dispersed in isopropanol, 40-50 nm particle size. Supplied at 30% |
| | solids from Nissan Chemical America Corporation, as IPA-ST-L |
| IPA-ST-ZL | Silica nanoparticles dispersed in isopropanol, 70-100 nm particle size. Supplied at |
| | 30% solids from Nissan Chemical America Corporation, as IPA-ST-ZL |
| IPA-ST-UP | Elongated silica nanoparticles dispersed in isopropanol, 9-15 nm particle strand |
| | diameter and 40-100 nm overall length. Supplied at 15% solids from Nissan |
| | Chemical America Corporation, as IPA-ST-UP |
| PGME | Propylene glycol methyl ether or 1-methoxy-2-propanol available from Sigma |
| | Aldrich, St. Louis, Missouri |
| NALCO 2326 | Colloidal silica having a nominal particle size of 5 nm obtained under the trade |
| | designation NALCO 2326 from Nalco Company, Bedford Park, IL |
| NALCO 2327 | Colloidal silica having a nominal particle size of 20 nm obtained under the trade |
| | designation NALCO 2327 from Nalco Company |
| NALCO 2329 | Colloidal silica having a nominal particle size of 75 nm obtained under the trade |
| | designation NALCO 2329 from Nalco Company |
| MP1040 | Colloidal silica having a nominal particle size of 100 nm obtained under the trade |
| | designation MP1040 from Nissan Chemical America Corporation |
| MP2040 | Colloidal silica having a nominal particle size of 190 nm obtained under the trade |
| | designation MP2040 from Nissan Chemical America Corporation |
| MPS | 3-(methacryloyloxy)propyltrimethoxy silane obtained from Alfa Aesar, Ward Hill, |
| | MA |

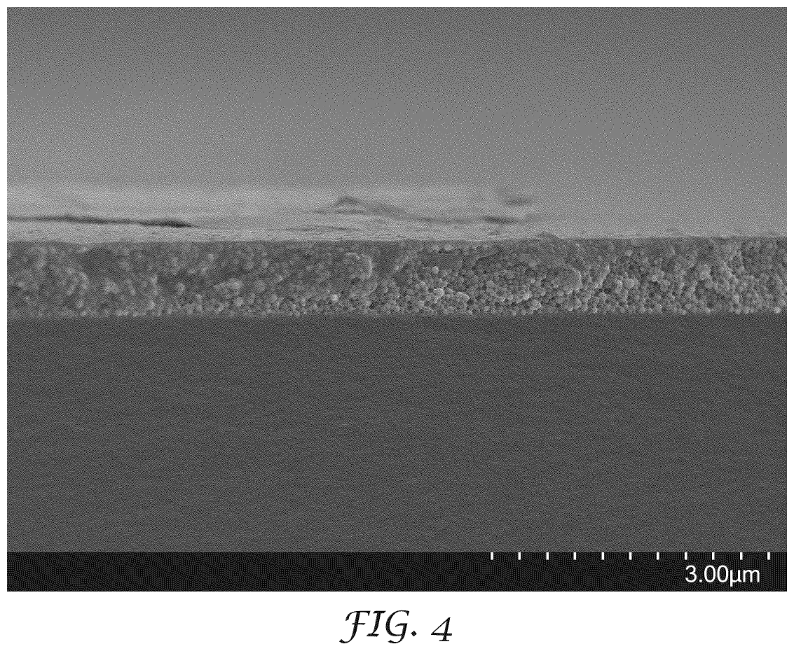

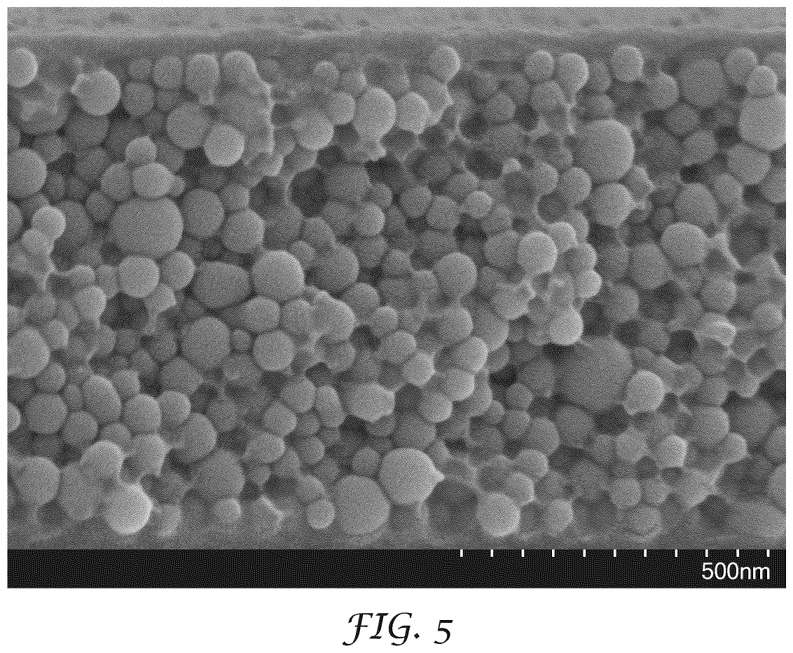

Methods Preparation of Surface-Modified Silica Nanoparticles: Silica nanoparticles of 190 nm, 100 nm, nm, 20 nm and 5 nm diameters were surface-modified according to the procedures disclosed in Preparatory Examples 2, 7, and 9 of U.S. Pat. Pub. 2015/0017386 A1 (Kolb et al.) The surface treatments were all 100% MPS, 3-(methacryloyloxy)propyltrimethoxy silane. Particle sizes and materials included: MP2040 for 190 nm silica nanoparticles, MP1040 for 100 nm silica nanoparticles, NALCO 2329 for 75 nm silica nanoparticles, NALCO 2327 for 20 nm silica nanoparticles, and NALCO 2326 for 5 nm silica nanoparticles. Preparation of Scanning Electron Microsope (“SEM”) Images: The imaged samples were Cryo-scalpel Loop cut, mounted onto cross section stubs, moderately coated with Au/Pd to prevent charging and imaged on the 8230 Hitachi Microscope. 3 kV imaging voltage (normal probe current), 15 kx-100 kx Magnification. FIG. 4 is an SEM image of a cross-section of an article prepared according to the present disclosure. FIG. 5 is an SEM image of a cross-section of the top layer (i.e., the nanoparticle layer) of the article of FIG. 4.

### Examples 1-4

### Different Nanoparticles Transferred from Polymeric Film PP1 Using Coating Solution PE1

TABLE 2
Composition of Preparatory Example 1 for Examples 1-8

| Preparatory | | | | |
|---|---|---|---|---|
| Example | SR238 | SR9035 | IRG184 | IRGTPO |
| PE1 | 49 | 49 | 0.8 | 1.2 |

UV-curable coating solution PE1 was prepared by dissolving a photo-initiator blend (40/60 blend of IRG184 and IRGTPO; 2 wt. %) into a UV-curable resin blend (50/50 blend of

SR238B and SR9035; 98 wt. %) as supplied from the manufacturer, according to Table 2.

TABLE 3
Composition of Preparatory Examples 2-5 for Examples 1-12

| | | | Dilution | |
|---|---|---|---|---|
| Preparatory | Nanoparticle | Wt. % as | Factor | Final Wt. |
| Example | Identity | Supplied | by Weight | % SiO₂ |
| PE2 | IPA-ST | 30 | 1:4 | 7.5 |
| PE3 | IPA-ST-L | 30 | 1:4 | 7.5 |
| PE4 | IPA-ST-ZL | 30 | 1:4 | 7.5 |
| PE5 | IPA-ST-UP | 15 | 1:2 | 7.5 |

Nanoparticle dispersions were prepared by diluting IPA-ST, IPA-ST-L, IPA-ST-ZL, and IPA-ST-UP as supplied from the manufacturer to 7.5 weight percent with isopropanol, according to Table 3. The nanoparticle dispersions were mixed with high agitation on a vortex mixer. PP1, used as received, was cut into an 8 in×10 in (20 cm×25 cm) sheet. The PP1 sheet was placed upon a flat glass surface. Each nanoparticle dispersion, PE2-PES, from Table 3 above was coated onto a separate sheet of PP1 with Mayer rod #6 (R D Specialties, Webster, N.Y.). Each of the Mayer rod coatings was approximately 7 in×9 in (18 cm×23 cm). All coatings were allowed to air dry for 2-24 hours at room temperature.

Once dried, the nanoparticle coatings were trimmed to approximately 6 in×9 in (15 cm×23 cm). Additionally, one sheet of PP1 without any coating was similarly trimmed. Each of the nanoparticle coatings and the uncoated PP1 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE1, the primed side of PET1 was against the uncoated PP1. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating to spread the PE1 while simultaneously laminating PET1 to the nanoparticle coating. This technique, wherein the Mayer rod never directly touches the coating formula, PE1, eliminates air from becoming entrained in the laminate. In the case of CE1, the coating formula, PE1, is spread between PET1 and an uncoated sheet of PP1.

The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP1 sheet.

The initial transmission and haze of Examples 1-4 and CE1 were measured with a BYK HAZE GARD I instrument (BYK Instruments, Geretsried, Germany). Results are shown in Table 4.

The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument. Results are shown in Table 4.

TABLE 4
Hardcoat Testing

| | Nano- | Average | Average | Average | Average | | |
|---|---|---|---|---|---|---|---|
| | particle | Initial | Initial | Final | Final | Delta | Delta |
| Example | Layer | Transmission | Haze | Transmission | Haze | Transmission | Haze |
| CE1 | None | 92.2 | 1.19 | 91.0 | 5.90 | −1.2 | 4.71 |
| 1 | IPA-ST | 92.2 | 1.21 | 91.1 | 11.7 | −1.1 | 10.5 |
| | (PE2) | | | | | | |
| 2 | IPA-ST-L | 92.4 | 1.18 | 91.4 | 7.93 | −1.0 | 6.75 |
| | (PE3) | | | | | | |
| 3 | IPA-ST-ZL | 92.4 | 1.15 | 91.4 | 12.7 | −1.0 | 11.6 |
| | (PE4) | | | | | | |
| 4 | IPA-ST-UP | 92.3 | 1.22 | 91.3 | 4.00 | −1.0 | 2.78 |
| | (PE5) | | | | | | |

### Examples 5-8

### Different Nanoparticles Transferred from Polymeric Film PP2 Using Coating Solution PE1

PP2, used as received, was cut into an 8 in×10 in (20 cm×25 cm) sheet. The PP2 sheet was placed upon a flat glass surface. Each nanoparticle dispersion, PE2-PES, from Table 3 above was coated onto a separate sheet of PP2 with Mayer rod #6 (R D Specialties, Webster, N.Y.). Each of the Mayer rod coatings was approximately 7 in×9 in (18 cm×23 cm). All coatings were allowed to air dry for 2-24 hours at room temperature.

Once dried, the nanoparticle coatings were trimmed to approximately 6 in×9 in (15 cm×23 cm). Additionally, one sheet of PP2 without any coating was similarly trimmed. Each of the nanoparticle coatings and the uncoated PP2 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE2, the primed side of PET1 was against the uncoated PP2. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating to spread the PE1 while simultaneously laminating PET1 to the nanoparticle coating. This technique, wherein the Mayer rod never directly touches the coating formula, PE1, eliminates air from becoming entrained in the laminate. In the case of CE2, the coating formula, PE1, is spread between PET1 and an uncoated sheet of PP2.

The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP2 sheet.

The initial transmission and haze of Examples 5-8 and CE2 were measured with a BYK HAZE GARD I instrument (BYK Instruments, Geretsried, Germany). Results are shown in Table 5.

The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument. Results are shown in Table 5.

TABLE 5
Hardcoat Testing

| | Nano- | Average | Average | Average | Average | | |
|---|---|---|---|---|---|---|---|
| | particle | Initial | Initial | Final | Final | Delta | Delta |
| Example | Layer | Transmission | Haze | Transmission | Haze | Transmission | Haze |
| CE2 | None | 92.1 | 1.25 | 91.1 | 4.61 | −1.0 | 3.36 |
| 5 | IPA-ST | 92.4 | 1.19 | 91.4 | 5.35 | −1.0 | 4.16 |
| | (PE2) | | | | | | |
| 6 | IPA-ST-L | 92.4 | 1.14 | 91.3 | 7.68 | −1.1 | 6.54 |
| | (PE3) | | | | | | |
| 7 | IPA-ST-ZL | 92.3 | 1.16 | 91.5 | 10.8 | −0.8 | 9.64 |
| | (PE4) | | | | | | |
| 8 | IPA-ST-UP | 92.3 | 1.34 | 91.2 | 3.57 | −1.1 | 2.23 |
| | (PE5) | | | | | | |

### Examples 9-12

### Different Nanoparticles Transferred from Polymeric Film PP1 Using Coating Solution PE6

TABLE 6
Composition of Preparatory Example 6 for Examples 9-12

| Preparatory | | | | |
|---|---|---|---|---|
| Example | SR238 | SR295 | IRG184 | IRGTPO |
| PE6 | 49 | 49 | 0.8 | 1.2 |

PP1, used as received, was cut into an 8 in×10 in (20 cm×25 cm) sheet. The PP1 sheet was placed upon a flat glass surface. Each nanoparticle dispersion, PE2-PES, from Table 3 above was coated onto a separate sheet of PP1 with Mayer rod #6 (R D Specialties, Webster, N.Y.). Each of the Mayer rod coatings was approximately 7 in×9 in (18 cm×23 cm). All coatings were allowed to air dry for 2-24 hours at room temperature.

Once dried, the nanoparticle coatings were trimmed to approximately 6 in×9 in (15 cm×23 cm). Additionally, one sheet of PP1 without any coating was similarly trimmed. Each of the nanoparticle coatings and the uncoated PP1 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE3, the primed side of PET1 was against the uncoated PP1. PET1 was carefully rolled back from the nanoparticle coating (where applicable) and over

Mayer rod #6. A 0.5 mL bead of PE6 was deposited onto the nanoparticle coating with a disposable pipette. The Mayer rod was moved across the surface of the nanoparticle coating to spread the PE6 while simultaneously laminating PET1 to the nanoparticle coating. This technique, wherein the Mayer rod never directly touches the coating formula, PE6, eliminates air from becoming entrained in the laminate. In the case of CE3, the coating formula, PE6, is spread between PET1 and an uncoated sheet of PP1.

The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP1 sheet. The initial transmission and haze of Examples 9-12 and CE3 were measured with a BYK

HAZE GARD I instrument (BYK Instruments, Geretsried, Germany). Results are shown in Table 7. The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument. Results are shown in Table 7.

TABLE 7
Hardcoat Testing

| | Nano- | Average | Average | Average | Average | | |
|---|---|---|---|---|---|---|---|
| | particle | Initial | Initial | Final | Final | Delta | Delta |
| Example | Layer | Transmission | Haze | Transmission | Haze | Transmission | Haze |
| CE3 | None | 92.0 | 1.24 | 90.8 | 6.11 | −1.2 | 4.87 |
| 9 | IPA-ST | 92.4 | 1.18 | 90.8 | 11.8 | −1.6 | 10.6 |
| | (PE2) | | | | | | |
| 10 | IPA-ST-L | 92.4 | 1.11 | 91.1 | 6.12 | −1.3 | 5.01 |
| | (PE3) | | | | | | |
| 11 | IPA-ST-ZL | 92.5 | 1.13 | 91.2 | 7.50 | −1.3 | 6.37 |
| | (PE4) | | | | | | |
| 12 | IPA-ST-UP | 92.4 | 1.20 | 91.0 | 5.17 | −1.4 | 3.97 |
| | (PE5) | | | | | | |

### Examples 13-21

### Nanoparticle Dispersions Coated onto Donor Polymeric Film at Different Concentrations

TABLE 8
Composition of Preparatory Examples 7-13 for Examples 13-21

| | | | Dilution | |
|---|---|---|---|---|
| Preparatory | Nanoparticle | Wt. % as | Factor | Final Wt. |
| Example | Identity | Supplied | by Weight | % SiO₂ |
| PE7 | IPA-ST-L | 30 | 1:40 | 0.75 |
| PE8 | IPA-ST-L | 30 | 1:12 | 2.5 |
| PE9 | IPA-ST-L | 30 | 1:2 | 15 |
| PE10 | IPA-ST-L | 30 | None | 30 |
| PE11 | IPA-ST-UP | 15 | 1:20 | 0.75 |
| PE12 | IPA-ST-UP | 15 | 1:6 | 2.5 |
| PE13 | IPA-ST-UP | 15 | None | 15 |

Nanoparticle dispersions were prepared by diluting IPA-ST-L and IPA-ST-UP with isopropanol, according to Table 8. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE7-PE13, from Table 8 above, along with PE3 and PE5 was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature.

Once dried, the nanoparticle coatings were trimmed to approximately 6 in×10 in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE4, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating to spread the PE1 while simultaneously laminating PET1 to the nanoparticle coating. This technique, wherein the Mayer rod never directly touches the coating formula, PE1, eliminates air from becoming entrained in the laminate. In the case of CE4, the coating formula, PE1, is spread between PET1 and an uncoated sheet of PP3.

The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3. SEM analysis revealed that the nanoparticles that were removed from the surface of PP3 became concentrated at the surface of the cured coating that had been adjacent to the PP3 film.

The initial transmission and haze of Examples 13-21 and CE4 were measured with a BYK HAZE GARD I instrument (BYK Instruments, Geretsried, Germany). Results are shown in Table 9. The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument. Results are shown in Table 9.

TABLE 9
Hardcoat Testing

| | | Nano- | | | | | | |
|---|---|---|---|---|---|---|---|---|
| | | particle | | | | | | |
| | Nano- | Concentration | Average | Average | Average | Average | | |
| | particle | in Transfer | Initial | Initial | Final | Final | Delta | Delta |
| Example | Layer | Layer | Transmission | Haze | Transmission | Haze | Transmission | Haze |
| CE4 | None | N/A | 92.3 | 0.41 | 91.2 | 4.25 | −1.1 | 3.84 |
| 13 | IPA-ST-L | 0.75% | 92.6 | 0.40 | 91.3 | 4.39 | −1.3 | 3.99 |
| | (PE7) | | | | | | | |
| 14 | IPA-ST-L | 2.5% | 92.3 | 0.38 | 91.2 | 5.45 | −1.1 | 5.07 |
| | (PE8) | | | | | | | |
| 15 | IPA-ST-L | 7.5% | 92.5 | 0.37 | 91.5 | 8.13 | −1.0 | 7.76 |
| | (PE3) | | | | | | | |
| 16 | IPA-ST-L | 15% | 92.5 | 0.40 | 91.4 | 6.63 | −1.1 | 6.23 |
| | (PE9) | | | | | | | |
| 17 | IPA-ST-L | 30% | 92.1 | 2.23 | 91.3 | 13.6 | −0.8 | 11.4 |
| | (PE10) | | | | | | | |
| 18 | IPA-ST-UP | 0.75% | 92.3 | 0.45 | 91.3 | 3.54 | −1.0 | 3.09 |
| | (PE11) | | | | | | | |
| 19 | IPA-ST-UP | 2.5% | 92.4 | 0.41 | 91.3 | 4.77 | −1.1 | 4.36 |
| | (PE12) | | | | | | | |
| 20 | IPA-ST-UP | 7.5% | 92.4 | 0.44 | 91.4 | 3.26 | −1.0 | 2.82 |
| | (PE5) | | | | | | | |
| 21 | IPA-ST-UP | 15% | 92.4 | 0.47 | 91.5 | 3.99 | −0.9 | 3.52 |
| | (PE13) | | | | | | | |

### Comparative Examples 5-12

### Coatings with IPA-ST-L Nanoparticles in the Bulk Coating Solution

TABLE 10
Composition of Preparatory Examples
22-29 for Comparative Examples 5-12

| Preparatory | | | | | IPA- | Isopro- |
|---|---|---|---|---|---|---|
| Example | SR238 | SR9035 | IRG184 | IRGTPO | ST-L | panol |
| PE14 | 24.5 | 24.5 | 0.4 | 0.6 | 0 | 50 |
| PE15 | 23 | 23 | 0.4 | 0.6 | 10 | 43 |
| PE16 | 21.5 | 21.5 | 0.4 | 0.6 | 20 | 36 |
| PE17 | 20 | 20 | 0.4 | 0.6 | 30 | 29 |
| PE18 | 18.5 | 18.5 | 0.4 | 0.6 | 40 | 22 |
| PE19 | 17 | 17 | 0.4 | 0.6 | 50 | 15 |
| PE20 | 15.5 | 15.5 | 0.4 | 0.6 | 60 | 8 |
| PE21 | 14 | 14 | 0.4 | 0.6 | 70 | 1 |

UV-curable coating solutions PE14-21 were prepared according to Table 10. UV-curable coating solutions PE14-21 were mixed on a jar roller overnight. The UV-curable coating solutions from Table 10 above were coated onto the primed side of PET1 film. Each of the UV-curable coating solutions PE14-PE21 was coated with Mayer rod #9 (R D Specialties, Webster, N.Y.). Each of the Mayer rod coatings was approximately 5 in×7 in (12.7 cm×17.8 cm); a size sufficient for Taber abrasion testing. PET1 films with PE14-21 coated thereupon were dried for 45 seconds at 80° C. The dried coatings were placed under a medium pressure mercury H bulb radiation source, with the UV-curable coating being the topmost layer. The UV processor with the medium pressure mercury H bulb radiation source was a HERAEUS FUSION UV SYSTEMS INC. unit equipped with a LIGHT HAMMER 6 Model LH6 500 W/in (200 W/cm) power source. An H bulb was used at 100% power setting, and the process area was purged with nitrogen gas. The film/coating was carried through the UV processor by a conveyor belt system at a speed of 40 ft/min (12.192 m/min).

The initial transmission and haze of Comparative Examples 5-12 were measured with a BYK HAZE GARD I instrument (BYK Instruments, Geretsried, Germany). Results are shown in Table 11. The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument. Results are shown in Table 11.

TABLE 11
Hardcoat Testing

| | UV-Curable | Average | Average | Average | Average | | |
|---|---|---|---|---|---|---|---|
| | Coating | Initial | Initial | Final | Final | Delta | Delta |
| Example | Solution | Transmission | Haze | Transmission | Haze | Transmission | Haze |
| CE5 | PE14 | 92.4 | 0.21 | 91.5 | 3.21 | −0.9 | 3.00 |
| CE6 | PE15 | 92.4 | 0.20 | 91.3 | 3.31 | −1.1 | 3.11 |
| CE7 | PE16 | 92.3 | 0.22 | 91.2 | 3.71 | −1.1 | 3.49 |
| CE8 | PE17 | 92.4 | 0.21 | 91.3 | 4.01 | −1.1 | 3.80 |
| CE9 | PE18 | 92.4 | 0.25 | 91.3 | 3.80 | −1.1 | 3.55 |
| CE10 | PE19 | 92.5 | 0.22 | 91.2 | 4.62 | −1.3 | 4.40 |
| CE11 | PE20 | 92.4 | 0.21 | 91.3 | 5.31 | −1.1 | 5.10 |
| CE12 | PE21 | 92.5 | 0.21 | 91.3 | 7.37 | −1.2 | 7.16 |

### Comparative Examples 13-21

### Coatings with IPA-ST-UP Nanoparticles in the Bulk Coating Solution

TABLE 12
Composition of Preparatory Examples
22-30 for Comparative Examples 13-21

| Preparatory | | | | | IPA- | Isopro- |
|---|---|---|---|---|---|---|
| Example | SR238 | SR9035 | IRG184 | IRGTPO | ST-UP | panol |
| PE22 | 14.7 | 14.7 | 0.24 | 0.36 | 0 | 70 |
| PE23 | 13.95 | 13.95 | 0.24 | 0.36 | 10 | 61.5 |
| PE24 | 13.2 | 13.2 | 0.24 | 0.36 | 20 | 53 |
| PE25 | 12.45 | 12.45 | 0.24 | 0.36 | 30 | 44.5 |
| PE26 | 11.7 | 11.7 | 0.24 | 0.36 | 40 | 36 |
| PE27 | 10.95 | 10.95 | 0.24 | 0.36 | 50 | 27.5 |
| PE28 | 10.2 | 10.2 | 0.24 | 0.36 | 60 | 19 |
| PE29 | 9.45 | 9.45 | 0.24 | 0.36 | 70 | 10.5 |
| PE30 | 8.7 | 8.7 | 0.24 | 0.36 | 80 | 2 |

UV-curable coating solutions PE22-30 were prepared according to Table 12. UV-curable coating solutions PE22-30 were mixed on a jar roller overnight. The UV-curable coating solutions from Table 12 above were coated onto the primed side of PET1 film. Each of the UV-curable coating solutions PE22-30 was coated with Mayer rod #14 (R D Specialties, Webster, N.Y.). Each of the Mayer rod coatings was approximately 5 in×7 in (12.7 cm×17.8 cm); a size sufficient for Taber abrasion testing. PET1 films with PE22-30 coated thereupon were dried for 45 seconds at 80° C. The dried coatings were placed under a medium pressure mercury H bulb radiation source, with the UV-curable coating being the topmost layer. The UV processor with the medium pressure mercury H bulb radiation source was a HERAEUS FUSION UV SYSTEMS INC. unit equipped with a LIGHT HAMMER 6 Model LH6 500 W/in (200 W/cm) power source. An H bulb was used at 100% power setting, and the process area was purged with nitrogen gas. The film/coating was carried through the UV processor by a conveyor belt system at a speed of 40 ft/min (12.192 m/min).

The initial transmission and haze of Comparative Examples 13-21 were measured with a BYK HAZE GARD I instrument (BYK Instruments, Geretsried, Germany). Results are shown in Table 13. The Examples were tested for abrasion resistance according to ASTM D1044-13.

Two specimens for each condition were tested and the results averaged. CS-10F abrasive wheels, 100 cycles, 500 g load, 60 cycles/min. The post-abrasion (final) haze and transmission were measured on the same instrument. Results are shown in Table 13.

TABLE 13
Hardcoat Testing

| | UV-Curable | Average | Average | Average | Average | | |
|---|---|---|---|---|---|---|---|
| | Coating | Initial | Initial | Final | Final | Delta | Delta |
| Example | Solution | Transmission | Haze | Transmission | Haze | Transmission | Haze |
| CE13 | PE22 | 92.3 | 0.22 | 91.3 | 4.30 | −1.0 | 4.08 |
| CE14 | PE23 | 92.3 | 0.86 | 91.2 | 6.44 | −1.1 | 5.58 |
| CE15 | PE24 | 92.3 | 0.66 | 91.2 | 6.42 | −1.1 | 5.76 |
| CE16 | PE25 | 92.3 | 0.65 | 91.1 | 5.59 | −1.2 | 4.94 |
| CE17 | PE26 | 92.3 | 0.44 | 91.1 | 5.13 | −1.2 | 4.69 |
| CE18 | PE27 | 92.2 | 0.39 | 91.2 | 4.10 | −1.0 | 3.72 |
| CE19 | PE28 | 92.4 | 0.34 | 91.3 | 3.04 | −1.1 | 2.70 |
| CE20 | PE29 | 92.6 | 0.51 | 91.4 | 3.48 | −1.2 | 2.97 |
| CE21 | PE30 | 92.6 | 0.41 | 91.5 | 3.25 | −1.1 | 2.84 |

### Examples 22-25

### Thermoformable Compositions

TABLE 14
Composition of Preparatory Examples 39-46 for Examples 22-25

| Prep. | | | | | | | | | ESACURE |
|---|---|---|---|---|---|---|---|---|---|
| Ex. | EB4513 | CN991 | SR420 | SR506 | SR238 | SR285 | NBYK3605 | IRG819 | ONE |
| PE39 | 68 | 0 | 10 | 5 | 10 | 5 | 0 | 1 | 1 |
| PE40 | 0 | 68 | 10 | 5 | 10 | 5 | 0 | 1 | 1 |
| PE41 | 66 | 0 | 10 | 5 | 8 | 5 | 4 | 1 | 1 |
| PE42 | 0 | 66 | 10 | 5 | 8 | 5 | 4 | 1 | 1 |
| PE43 | 63 | 0 | 10 | 5 | 5 | 5 | 10 | 1 | 1 |
| PE44 | 0 | 63 | 10 | 5 | 5 | 5 | 10 | 1 | 1 |
| PE45 | 58 | 0 | 10 | 5 | 0 | 5 | 20 | 1 | 1 |
| PE46 | 0 | 58 | 10 | 5 | 0 | 5 | 20 | 1 | 1 |

UV-curable coating solutions PE39-46 were prepared by dissolving a photo-initiator blend (50/50 blend of IRG819 and ESACURE ONE; 2 wt.%) into a UV-curable resin blend as 10 supplied from the manufacturer, according to Table 14. PP3,used as received, was cut into an 12 in×12 in (30.5 cm×30.5 cm) sheet. The PP3 sheet was placed upon a flat glass surface. Each nanoparticle dispersion, PE3, PES, PE9 and PE13, from the tables above was coated onto a separate sheet of PP3 with Mayer rod #6 (R D Specialties, Webster, N.Y.). Each of the Mayer rod coatings was approximately 10 in×10 in (25 cm×25 cm). All coatings were allowed to air dry for 2-24 hours at room temperature. Once dried, the nanoparticle coatings were trimmed to approximately 10 in×10 in (25 cm×25 cm). Additionally, eight sheets of PP3 without any coating were similarly trimmed. Each of the nanoparticle coatings and the blank PP3 sheets was placed upon a flat glass surface with the nanoparticle side up (where applicable). A 10 in×10 in (25 cm×25 cm) piece of PC1 film was gently laid upon the dried nanoparticle coating with a side of PCI against the nanoparticle coating. In the cases of CE23, CE24, CE29, CE30, CE31, CE32, CE33 and CE34, the primed side of PC1 was against the uncoated PP3. PC1 was carefully rolled back from the nanoparticle coating (where applicable) and over Mayer rod #6. A 1 mL bead of each PE39 and PE40 was deposited onto the nanoparticle coating with a disposable pipette. The Mayer rod was moved across the surface of the nanoparticle coating in order to effect the spreading of PE39 or PE40 while simultaneously laminating PC1 to the nanoparticle coating. This technique, wherein the Mayer rod never directly touches the coating formulas, PE39 or PE40, eliminates air from becoming entrained in the laminate. In the cases of CE23, CE24, CE29, CE30, CE31, CE32, CE33, CE34, the coating formulas, PE39-46, are spread between PCI and an uncoated sheet of PP3. The laminates were placed under combination medium pressure mercury D and H bulb radiation sources, with the PP3 film being the topmost layer. The UV processor with the medium pressure mercury D and H bulb radiation sources was a HERAEUS FUSION UV SYSTEMS INC. unit equipped with a LIGHT HAMMER 10 Model LH10 600 W/in (240 W/cm) power source with the output power set to 100%. The laminates were carried through the UV processor by a conveyor belt system at a speed of 60 feet/minute (18.3 m/minute). The PC1 film and the cured coating with captured nanoparticles (where applicable) were peeled as a unit from the surface of the PP3.

### Thermoforming Process

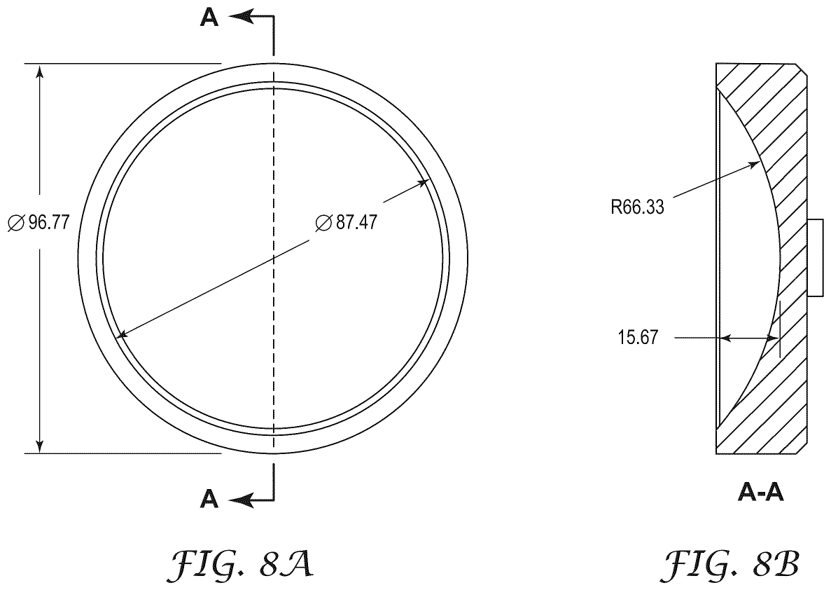

Samples were formed using HY-TECH ACCUFORM IL-50 thermoforming equipment (Hy-Tech Forming Systems, Phoenix, Arizona, USA) using the process conditions listed in Table 15. The mold geometry used is described as the 8-base geometry, made of PORTEC METAPOR HD 210 AL (Portec, Aadorf, Switzerland) to allow air to vent from below the film without causing large witness marks from vent locations. The 8-base thermoforming mold, shown in FIGS. 8A and 8B, is accompanied by a matching 8-base injection mold described below.

ACCUFORM IL-50 Machine Layout: an upper platen that is heated using resistive heating elements to a set temperature controlled to +/−10 F., this platen travels vertically to clamp the film between the upper and lower platen to make a pressure chamber. The lower platen has the mold geometry mounted; in this case a negative mold version of the 8-base thermoforming mold was used.

ACCUFORM IL-50 Process: the film is placed on top of the lower platen, completely covering the mold area allowing for a seal to form using the film itself as a gasket between the upper and lower platens. When the cycle is started the clamp closes, the clamp of the machine is designed to always use 50 tons of clamp force to maintain parting line seal when closed and under pressure. When the clamp closes the preheat cycle begins and the preheat timer starts counting down, the film is blown up against the upper platen using the preheat pressure setpoint, this keeps the film in intimate contact with the heated upper platen. When the preheat timer expires, the pressure is vented to atmosphere and the form pressure is applied through the upper platen and on the top side of the film, this forces the heated film downward against the mold surface replicating the mold geometry. When the form timer expires, the form pressure is vented to atmosphere for the release time. The clamp then opens when the release timer expires. This completes the cycle.

TABLE 15
Thermoforming Process Conditions

| | | |
|---|---|---|
| Setting | Imperial | SI |

| Heated Platen Temperature | 320 | F. | 160 | C. |
|---|---|---|---|---|
| Mold Temperature | 80 | F. | 26.7 | C. |
| Preheat Time | 6 s | | | |
| Preheat Pressure | 60 | psi | 414 | Kpa |

| | |
|---|---|
| Form Time | 6 s |
| Release Time | 1 s |

### Insert Molding

Thermoformed 8-base samples were trimmed using scissors to a dimension that was smaller than the optical surface of the injection mold. This was traced onto each film using the optical insert as a guide.

The samples were held into place against the optical surface of the convex side of the lens using static pinning, with a SIMCO-ION CHARGEMASTER VCM30 (Simco-Ion, Hatfield, Pa., USA) set to −11 Kv to charge the film and cause it to cling to the grounded tool surface.

The injection molding machine used was a ENGEL EM 310/180T (Engel, Schwertberg, Austria) all electric injection 180 ton injection molding machine, with a 25 mm screw/barrel. The injection molding process specific conditions are listed in Table 16, the process outline is as follows. The film is placed into the stationary side of the mold (concave optical mold cavity) and held in place with static pinning by manually placing the film in the desired location and slowly passing a SIMCO-ION LINEAR PINNER over top of the sample to completely charge the surface. The injection molding cycle is started, the mold is closed, material is injected through the sprue, runner, and gate into the part during the fill phase with a set injection velocity until the part is 99% full (Velocity Pressure Transfer—VPT). At the VPT the press switches control logic and stops using velocity control and begins the hold phase using pressure control of the screw, this fills the remaining 1% of the cavity and maintains cavity pressure while the part is cooling until the gate freezes (hold time). After the gate freezes the cooling timer starts and the screw begins to rotate to build the next shot of material for the subsequent cycle. After the cooling timer expires the mold opens, and the ejector system cycles to remove the part from the cavity.

The ejector system was programmed to remain forward and not fully eject the part to prevent it falling and getting damaged. The operator door was opened, the part was removed and packaged for transport.

TABLE 16
Engel EM 310/180T Molding Machine Process Conditions

| | | |
|---|---|---|
| Setting | Imperial | SI |

| Resin | Mitsubishi Iupilon - HL4002 | | | |
|---|---|---|---|---|
| Velocity | 5 | in/s | 127 | mm/s |
| Fill time | 0.37 s | | | |
| Pressure at switchover | 11500 | Psi | 79290 | Kpa |
| Screw back position | 2 | in | 50.8 | mm |
| Screw suckback | 0.1 | in | 2.54 | mm |
| Transfer Position | 0.39 | in | 9.9 | mm |
| Cushion Position | 0.239 | in | 6.07 | mm |
| Screw RPM | 120 | | | |
| Back Pressure | 1000 | Psi | 6895 | Kpa |
| Hold Time | 16 s | | | |
| Hold Pressure | 4000 | Psi | 27579 | Kpa |
| Cool Time | 30 s | | | |
| Clamp Force | 80 | US Ton | 712 | Kn |
| Screw Size | 0.984 | in | 25 | mm |
| Mold set temperature A | 200 | F. | 93.3 | C. |
| Mold set temperature B | 200 | F. | 93.3 | C. |
| Nozzle Temperature | 530 | F. | 277 | C. |
| Barrel Temperature 1 | 540 | F. | 232 | C. |
| Barrel Temperature 2 | 480 | F. | 249 | C. |
| Barrel Temperature 3 | 470 | F. | 443 | C. |
| Feed throat Temperature | 175 | F. | 79 | C. |

TABLE 17
Thermoforming and Insert Molding Outcomes for
Examples 22-25 and Comparative Examples 22-34

| Example | | Nano-silica | 8-base Thermo- | Insert Molding |
|---|---|---|---|---|
| Number | Example Description | Disposition | forming Result | Result |
| CE22 | Polycarbonate Film, | None | 20/20 formed | 18/18 mold fine |
| | no coat | | | |
| CE23 | PC Film + Ebecryl | None | 6/6 formed | 3/6 cracked |
| | 4513 coat (PE39) | | | |
| CE24 | PC Film + CN991 | None | 6/6 formed | 6/6 molded fine |
| | coating (PE40) | | | (1 fouled by old |
| | | | | resin; 1 insert |
| | | | | damaged) |
| 22 | PC Film + Eb 4513 | Surface, 7.5% | 3/4 formed | 3/3 molded fine |
| | coating (PE39) + | parent coating | | |
| | IPA-ST-UP nanoparticles | conc. (PE5) | | |
| 23 | PC Film + Eb4513 | Surface, 7.5% | 4/4 formed | 2/4 cracked |
| | coating (PE39) + | parent coating | | |
| | IPA-ST-L nanoparticles | conc. (PE3) | | |
| 24 | PC Film + CN991 | Surface, 7.5% | 4/4 formed | 4/4 molded fine |
| | coating (PE40) + | parent coating | | |
| | IPA-ST-UP nanoparticles | conc. (PE5) | | |
| 25 | PC Film + CN991 | Surface, 7.5% | 4/4 formed | 4/4 molded fine |
| | coating (PE40) + | parent coating | | |
| | IPA-ST-L nanoparticles | conc. (PE3) | | |
| CE25 | PC Film + Eb 4513 | Surface, 15% | 2/2 cracked | N/A |
| | coating (PE39) + | parent coating | | |
| | IPA-ST-UP nanoparticles | conc. (PE13) | | |
| CE26 | PC Film + Eb4513 | Surface, 15% | 2/2 hazed | N/A |
| | coating (PE39) + | parent coating | | |
| | IPA-ST-L nanoparticles | conc. (PE9) | | |
| CE27 | PC Film + CN991 | Surface, 15% | 2/2 cracked | N/A |
| | coating (PE40) + | parent coating | | |
| | IPA-ST-UP nanoparticles | conc. (PE13) | | |
| CE28 | PC Film + CN991 | Surface, 15% | 2/2 hazed | N/A |
| | coating (PE40) + | parent coating | | |
| | IPA-ST-L nanoparticles | conc. (PE9) | | |
| CE29 | PC Film + Eb4513 | Bulk, 2% in | 2/2 formed | 1/2 cracked |
| | coating + NANOBYK | coating | | |
| | 3605 particles (PE41) | | | |
| CE30 | PC Film + Eb4513 | Bulk, 5% in | 4/6 cracked | 1/2 cracked |
| | coating + NANOBYK | coating | | |
| | 3605 particles (PE43) | | | |
| CE31 | PC Film + Eb4513 | Bulk, 10% in | 3/4 cracked | 1/1 molded fine |
| | coating + NANOBYK | coating | | |
| | 3605 particles (PE45) | | | |
| CE32 | PC Film + CN991 | Bulk, 2% in | 2/2 formed | 2/2 molded fine |
| | coating + NANOBYK | coating | | (1 fouled by old |
| | 3605 particles (PE42) | | | resin) |
| CE33 | PC Film + CN991 | Bulk, 5% in | 1/6 cracked | 1/5 cracked |
| | coating + NANOBYK | coating | | |
| | 3605 particles (PE44) | | | |
| CE34 | PC Film + CN991 | Bulk, 10% in | 4/4 formed | 2/4 cracked |
| | coating + NANOBYK | coating | | |
| | 3605 particles (PE46) | | | |

The initial transmission and haze of Examples 22-25, CE22-24, and CE29-34 were measured with a BYK HAZE GARD I instrument (BYK Instruments, Geretsried, Germany). Results are shown in Table 18. The Examples were tested for abrasion resistance according to MIL-PRF-32432. Specimen(s) for each condition were tested and the results averaged (where applicable). Abrasive eraser insert per MIL-E-12397B, 20 cycles, 1.1 kilogram load, 40 cycles/min. The post-abrasion (final) haze and transmission were measured on the same instrument. Results are shown in Table 18.

TABLE 18
Hardcoat Testing

| | | | | Post- | Post- | | |
|---|---|---|---|---|---|---|---|
| Example | Number | Initial | Initial | Abrasion | Abrasion | Delta | Delta |
| Number | Replicates | % Transmission | % Haze | % Transmission | % Haze | % Transmission | % Haze |
| CE22 | 5 | 92.3 | 1.25 | 87.7 | 44.7 | −4.6 | 43.5 |
| CE23 | 3 | 93.1 | 0.84 | 89.3 | 16.1 | −3.8 | 15.3 |
| CE24 | 4 | 93.1 | 0.92 | 89.4 | 16.9 | −3.7 | 16.0 |
| 22 | 3 | 93.3 | 1.35 | 91.9 | 7.88 | −1.4 | 6.53 |
| 23 | 2 | 93.5 | 1.15 | 90.9 | 7.22 | −2.6 | 6.07 |
| 24 | 4 | 93.4 | 0.95 | 91.8 | 9.10 | −1.6 | 8.15 |
| 25 | 4 | 93.3 | 2.40 | 90.8 | 10.1 | −2.5 | 7.70 |
| CE29 | 1 | 93.0 | 1.31 | 88.8 | 17.8 | −4.2 | 16.5 |
| CE30 | 1 | 92.5 | 1.17 | 88.9 | 16.2 | −3.6 | 15.0 |
| CE31 | 1 | 91.7 | 2.12 | 87.1 | 22.9 | −4.6 | 20.8 |
| CE32 | 1 | 92.8 | 1.29 | 88.5 | 18.4 | −4.3 | 17.1 |
| CE33 | 4 | 92.8 | 1.02 | 88.9 | 18.0 | −3.9 | 17.0 |
| CE34 | 2 | 92.3 | 1.27 | 88.3 | 18.1 | −4.0 | 16.8 |

### Examples 26-30

### 190 nm Size, Surface-Treated Silica Nanoparticles Coated onto Donor Polymeric Film at Different Dispersion Concentrations

TABLE 19
Composition of Preparatory Examples 39-43 for Examples 26-30

| Preparatory | Nanoparticle | Diluting | Final Wt. |
|---|---|---|---|
| Example | Size, nm | Solvent | % SiO₂ |
| PE39 | 190 | PGME | 0.5 |
| PE40 | 190 | PGME | 1.5 |
| PE41 | 190 | PGME | 3.0 |
| PE42 | 190 | PGME | 5.0 |
| PE43 | 190 | PGME | 7.5 |

Nanoparticle dispersions were prepared by diluting 190 nm surface treated nano-silica particles with 1-methoxy-2-propanol, according to Table 19. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE39-43, from Table 19 above, was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature. Once dried, the nanoparticle coatings were trimmed to approximately 6 in×10 in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE35, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating to effect the spreading of PE1 while simultaneously laminating PET1 to the nanoparticle coating. This technique, wherein the Mayer rod never directly touches the coating formula, PE1, eliminates air from becoming entrained in the laminate. In the case of CE35, the coating formula, PE1, is spread between PET1 and an uncoated sheet of PP3. The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3.

TABLE 20
Hardcoat Testing, Rotary Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE35 | None | N/A | 92.2 | 0.41 | 91.2 | 4.06 | −1.0 | 3.65 |
| 26 | 190 nm (PE39) | 0.5% | 92.2 | 0.41 | 91.0 | 4.48 | −1.2 | 4.07 |
| 27 | 190 nm (PE40) | 1.5% | 92.2 | 0.42 | 90.9 | 3.98 | −1.3 | 3.56 |
| 28 | 190 nm (PE41) | 3.0% | 92.2 | 0.41 | 91.1 | 5.13 | −1.1 | 4.72 |
| 29 | 190 nm (PE42) | 5.0% | 92.2 | 0.41 | 91.4 | 9.36 | −0.8 | 8.95 |
| 30 | 190 nm (PE43) | 7.5% | 92.3 | 0.39 | 91.4 | 13.4 | −0.9 | 13.0 |

The initial transmission and haze of Examples 26-30 and CE35 were measured with a BYK HAZE GARD I instrument (BYK Instruments, Geretsried, Germany). The results are shown Table 20. The examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

TABLE 21
Hardcoat Testing, Linear Taber Abrasion

| | | Nano- | | | | | | |
|---|---|---|---|---|---|---|---|---|
| | | particle | | | | | | |
| | | Concentration | Average | Average | Average | Average | | Delta |
| | Nano-particle | in Transfer | Initial | Initial | Final | Final | Delta | Haze |
| Example | Layer | Layer | Transmission | Haze | Transmission | Haze | Transmission | (%) |
| CE35 | None | N/A | 92.2 | 0.41 | 91.3 | 12.2 | −0.9 | 11.8 |
| 26 | 190 nm (PE39) | 0.5% | 92.2 | 0.41 | 91.5 | 12.5 | −0.7 | 12.1 |
| 27 | 190 nm (PE40) | 1.5% | 92.2 | 0.42 | 91.7 | 9.36 | −0.5 | 8.94 |
| 28 | 190 nm (PE41) | 3.0% | 92.2 | 0.41 | 92.0 | 6.34 | −0.2 | 5.93 |
| 29 | 190 nm (PE42) | 5.0% | 92.2 | 0.41 | 91.9 | 6.37 | −0.3 | 5.96 |
| 30 | 190 nm (PE43) | 7.5% | 92.3 | 0.39 | 92.2 | 6.52 | −0.1 | 6.13 |

The initial transmission and haze of Examples 26-30 and CE35 were measured with a BYK HAZE GARD I instrument (BYK Instruments, Geretsried, Germany). The results are shown Table 21. The Examples were tested for abrasion resistance according to ASTM D6279-15. Two specimens for each condition were tested and the results averaged. SCOTCH-BRITE 07448 abrasive pad (available from 3M), 40 cycles, 750 gram load, 3 in (7.6 cm) stroke length, cycles/min. The post-abrasion (final) haze and transmission were measured on the same instrument. The results are shown Table 21.

### Examples 31-35

### 100 nm Size, Surface-Treated Nanoparticles Coated onto Donor Polymeric Film at Different Dispersion Concentrations

TABLE 22
Composition of Preparatory Examples 44-48 for Examples 31-35

| Preparatory | Nanoparticle | Diluting | Final Wt. |
|---|---|---|---|
| Example | Size, nm | Solvent | % SiO2 |
| PE44 | 100 | PGME | 0.5 |
| PE45 | 100 | PGME | 1.5 |
| PE46 | 100 | PGME | 3.0 |
| PE47 | 100 | PGME | 5.0 |
| PE48 | 100 | PGME | 7.5 |

Nanoparticle dispersions were prepared by diluting 100 nm surface treated nano-silica particles with 1-methoxy-2-propanol, according to Table 22. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE44-48, from Table 22 above, was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature. Once dried, the nanoparticle coatings were trimmed to approximately 6 in×10 in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE36, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating in order to effect the spreading of PE1 while simultaneously laminating PET1 to the nanoparticle coating. This technique, wherein the Mayer rod never directly touches the coating formula, PE1, eliminates air from becoming entrained in the laminate. In the case of CE36, the coating formula, PE1, is spread between PET1 and an uncoated sheet of PP3. The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3.

TABLE 23
Hardcoat Testing, Rotary Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE36 | None | N/A | 92.2 | 0.42 | 91.0 | 4.49 | −1.2 | 4.07 |
| 31 | 100 nm (PE44) | 0.5% | 92.4 | 0.45 | 91.1 | 4.04 | −1.3 | 3.59 |
| 32 | 100 nm (PE45) | 1.5% | 92.7 | 0.41 | 91.4 | 4.34 | −1.3 | 3.93 |
| 33 | 100 nm (PE46) | 3.0% | 92.4 | 0.42 | 91.2 | 7.21 | −1.2 | 6.79 |
| 34 | 100 nm (PE47) | 5.0% | 92.3 | 0.39 | 91.4 | 9.11 | −0.9 | 8.72 |
| 35 | 100 nm (PE48) | 7.5% | 92.4 | 0.41 | 91.4 | 11.3 | −1.0 | 10.9 |

The initial transmission and haze of Examples 31-35 and CE36 were measured with a BYK HAZE GARD I instrument (BYK Instruments, Geretsried, Germany). The results are shown in Table 23. The Examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

TABLE 24
Hardcoat Testing, Linear Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | [symbol] | Transmission | Haze | Transmission | Haze | Transmission | Haze |
| CE36 | None | N/A | 92.2 | 0.42 | 91.0 | 15.2 | −1.2 | 14.8 |
| 31 | 100 nm [symbol] | 0.5% | 92.4 | 0.45 | 92.0 | 8.48 | −0.4 | 8.03 |
| 32 | 100 nm [symbol] | 1.5% | 92.7 | 0.41 | 92.4 | 5.89 | −0.3 | 5.48 |
| 33 | 100 nm (PE46) | 3.0% | 92.4 | 0.42 | 92.4 | 5.09 | 0.0 | 4.67 |
| 34 | 100 nm [symbol] | 5.0% | 92.3 | 0.39 | 92.5 | 4.96 | 0.2 | 4.57 |
| 35 | 100 nm [symbol] | 7.5% | 92.4 | 0.41 | 92.4 | 6.98 | 0.0 | 6.57 |

[symbol]

indicates data missing or illegible when filed

The initial transmission and haze of Examples 31-35 and CE36 were measured with a BYK HAZE GARD I instrument (BYK Instruments, Geretsried, Germany). The results are shown in the table above. The examples were tested for abrasion resistance according to ASTM D6279-15. Two specimens for each condition were tested and the results averaged. SCOTCH-BRITE 07448 abrasive pad (available from 3M), 40 cycles, 750 gram load, 3 in (7.6 cm) stroke length, 60 cycles/min. The post-abrasion (final) haze and transmission were measured on the same instrument.

### Examples 36-40

### 75 nm Size, Surface-Treated Nanoparticles Coated onto Donor Polymeric Film at Different Dispersion Concentrations

TABLE 25
Composition of Preparatory Examples 49-53 for Examples 36-40

| Preparatory | Nanoparticle | Diluting | Final Wt. |
|---|---|---|---|
| Example | Size, nm | Solvent | % SiO2 |
| PE49 | 75 | PGME | 0.5 |
| PE50 | 75 | PGME | 1.5 |
| PE51 | 75 | PGME | 3.0 |
| PE52 | 75 | PGME | 5.0 |
| PE53 | 75 | PGME | 7.5 |

Nanoparticle dispersions were prepared by diluting 75 nm surface treated nano-silica particles with 1-methoxy-2-propanol, according to Table 25. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE49-53, from Table 25 above, was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature. Once dried, the nanoparticle coatings were trimmed to approximately 6 in×in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE37, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating in order to effect the spreading of PE1 while simultaneously laminating PET1 to the nanoparticle coating. This technique, wherein the Mayer rod never directly touches the coating formula, PE1, eliminates air from becoming entrained in the laminate. In the case of CE37, the coating formula, PE1, is spread between PET1 and an uncoated sheet of PP3. The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3.

TABLE 26
Hardcoat Testing, Rotary Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE37 | None | N/A | 92.1 | 0.40 | 91.3 | 4.05 | −0.8 | 3.65 |
| 36 | 75 nm (PE49) | 0.5% | 92.4 | 0.40 | 91.4 | 4.96 | −1.0 | 4.56 |
| 37 | 75 nm (PE50) | 1.5% | 92.5 | 0.39 | 91.5 | 3.81 | −1.0 | 3.42 |
| 38 | 75 nm (PE51) | 3.0% | 92.3 | 0.38 | 91.6 | 6.19 | −0.7 | 5.81 |
| 39 | 75 nm (PE52) | 5.0% | 92.3 | 0.39 | 91.5 | 7.02 | −0.8 | 6.63 |
| 40 | 75 nm (PE53) | 7.5% | 92.4 | 0.36 | 91.6 | 7.06 | −0.8 | 6.70 |

The initial transmission and haze of Examples 36-40 and CE37 were measured with a BYK HAZE GARD I instrument (BYK Instruments, Geretsried, Germany). The results are shown in the table above. The examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

TABLE 27
Hardcoat Testing, Linear Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE37 | None | N/A | 92.1 | 0.40 | 91.2 | 15.2 | −0.9 | 14.8 |
| 36 | 75 nm (PE49) | 0.5% | 92.4 | 0.40 | 92.0 | 9.64 | −0.4 | 9.24 |
| 37 | 75 nm (PE50) | 1.5% | 92.5 | 0.39 | 92.6 | 5.62 | 0.1 | 5.23 |
| 38 | 75 nm (PE51) | 3.0% | 92.3 | 0.38 | 92.5 | 6.39 | 0.2 | 6.01 |
| 39 | 75 nm (PE52) | 5.0% | 92.3 | 0.39 | 92.6 | 6.02 | 0.3 | 5.63 |
| 40 | 75 nm (PE53) | 7.5% | 92.4 | 0.36 | 92.6 | 6.81 | 0.2 | 6.45 |

The initial transmission and haze of Examples 36-40 and CE37 were measured with a BYK HAZE GARD I instrument (BYK Instruments, Geretsried, Germany). The results are shown in the table above. The examples were tested for abrasion resistance according to ASTM D6279-15. Two specimens for each condition were tested and the results averaged. SCOTCH-BRITE 07448 abrasive pad (available from 3M), 40 cycles, 750 gram load, 3 in (7.6 cm) stroke length, 60 cycles/min. The post-abrasion (final) haze and transmission were measured on the same instrument.

### Examples 41-45

### 20 nm Size, Surface-Treated Nanoparticles Coated onto Donor Polymeric Film at Different Dispersion Concentrations

TABLE 28
Composition of Preparatory Examples 54-58 for Examples 41-45

| Preparatory | Nanoparticle | Diluting | Final Wt. |
|---|---|---|---|
| Example | Size, nm | Solvent | % SiO₂ |
| PE54 | 20 | PGME | 0.5 |
| PE55 | 20 | PGME | 1.5 |
| PE56 | 20 | PGME | 3.0 |
| PE57 | 20 | PGME | 5.0 |
| PE58 | 20 | PGME | 7.5 |

Nanoparticle dispersions were prepared by diluting 20 nm surface treated nano-silica particles with 1-methoxy-2-propanol, according to Table 28. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE54-58, from Table 28 above, was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature. Once dried, the nanoparticle coatings were trimmed to approximately 6 in×10 in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE38, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating in order to effect the spreading of PE1 while simultaneously laminating PET1 to the nanoparticle coating. This technique, wherein the Mayer rod never directly touches the coating formula, PE1, eliminates air from becoming entrained in the laminate. In the case of CE38, the coating formula, PE1, is spread between PET1 and an uncoated sheet of PP3. The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3.

TABLE 29
Hardcoat Testing, Rotary Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE38 | None | N/A | 92.1 | 0.42 | 91.0 | 3.77 | −1.1 | 3.35 |
| 41 | 20 nm (PE54) | 0.5% | 92.3 | 0.41 | 91.0 | 4.31 | −1.3 | 3.90 |
| 42 | 20 nm (PE55) | 1.5% | 92.5 | 0.43 | 91.4 | 3.50 | −1.1 | 3.07 |
| 43 | 20 nm (PE56) | 3.0% | 92.3 | 0.42 | 91.1 | 5.14 | −1.2 | 4.72 |
| 44 | 20 nm (PE57) | 5.0% | 92.3 | 0.42 | 91.0 | 6.62 | −1.3 | 6.20 |
| 45 | 20 nm (PE58) | 7.5% | 92.3 | 0.41 | 91.2 | 7.67 | −1.1 | 7.26 |

The initial transmission and haze of Examples 41-45 and CE38 were measured with a BYK HAZE GARD I instrument (BYK Instruments, Geretsried, Germany). The results are shown in the table above. The examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

TABLE 30
Hardcoat Testing, Linear Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE38 | None | N/A | 92.1 | 0.42 | 90.7 | 17.2 | −1.4 | 16.8 |
| 41 | 20 nm (PE54) | 0.5% | 92.3 | 0.41 | 91.0 | 15.70 | −1.3 | 15.3 |
| 42 | 20 nm (PE55) | 1.5% | 92.5 | 0.43 | 91.8 | 9.37 | −0.7 | 8.94 |
| 43 | 20 nm (PE56) | 3.0% | 92.3 | 0.42 | 92.1 | 5.95 | −0.2 | 5.53 |
| 44 | 20 nm (PE57) | 5.0% | 92.3 | 0.42 | 92.2 | 5.77 | −0.1 | 5.35 |
| 45 | 20 nm (PE58) | 7.5% | 92.3 | 0.41 | 92.3 | 4.81 | 0.0 | 4.40 |

The initial transmission and haze of Examples 41-45 and CE38 were measured with a BYK HAZE GARD I instrument (BYK Instruments, Geretsried, Germany). The results are shown in the table above. The examples were tested for abrasion resistance according to ASTM D6279-15. Two specimens for each condition were tested and the results averaged. SCOTCH-BRITE 07448 abrasive pad (available from 3M), 40 cycles, 750 gram load, 3 in (7.6 cm) stroke length, 60 cycles/min. The post-abrasion (final) haze and transmission were measured on the same instrument.

### Examples 46-50

### 5 nm Size, Surface-Treated Nanoparticles Coated onto Donor Polymeric Film at Different Dispersion Concentrations

TABLE 31
Composition of Preparatory Examples 59-63 for Examples 46-50

| Preparatory | Nanoparticle | Diluting | Final Wt. |
|---|---|---|---|
| Example | Size, nm | Solvent | % SiO2 |
| PE59 | 5 | PGME | 0.5 |
| PE60 | 5 | PGME | 1.5 |
| PE61 | 5 | PGME | 3.0 |
| PE62 | 5 | PGME | 5.0 |
| PE63 | 5 | PGME | 7.5 |

Nanoparticle dispersions were prepared by diluting 5 nm surface treated nano-silica particles with 1-methoxy-2-propanol, according to Table 31. The nanoparticle dispersions were mixed with high agitation on a vortex mixer. PP3, used as received, was cut into an 8 in×12 in (20 cm×30.5 cm) sheet. The PP3 sheet was placed upon a flat glass surface. Each nanoparticle dispersion, PE59-63, from Table 31 above, was coated onto a separate sheet of PP3 with Mayer rod #6 (R D Specialties, Webster, N.Y.). Each of the Mayer rod coatings was approximately 7 in×10 in (18 cm×25 cm). All coatings were allowed to air dry for 2-24 hours at room temperature. Once dried, the nanoparticle coatings were trimmed to approximately 6 in×10 in (15 cm×25 cm). Additionally, one sheet of PP3 without any coating was similarly trimmed. Each of the nanoparticle coatings and the blank PP3 was placed upon a flat glass surface with the nanoparticle side up (where applicable). A 6 in×9 in (15 cm×23 cm) piece of PET1 film was gently laid upon the dried nanoparticle coating with the primed side of PET1 against the nanoparticle coating. In the case of CE39, the primed side of PET1 was against the uncoated PP3. PET1 was carefully rolled back from the nanoparticle coating (where applicable) and over Mayer rod #6. A 0.5 mL bead of PE1 was deposited onto the nanoparticle coating with a disposable pipette. The Mayer rod was moved across the surface of the nanoparticle coating in order to effect the spreading of PE1 while simultaneously laminating PET1 to the nanoparticle coating. This technique, wherein the Mayer rod never directly touches the coating formula, PE1, eliminates air from becoming entrained in the laminate. In the case of CE39, the coating formula, PE1, is spread between PET1 and an uncoated sheet of PP3. The laminates were placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6 500 W/in (200 W/cm) power source with the output power set to 100%. The laminates were carried through the UV processor by a conveyor belt system at a speed of 40 feet/minute (12.2 m/minute). The PET1 film and the cured coating with captured nanoparticles (where applicable) were peeled as a unit from the surface of the PP3.

TABLE 32
Hardcoat Testing, Rotary Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE39 | None | N/A | 92.2 | 0.45 | 91.1 | 3.68 | −1.1 | 3.23 |
| 46 | 5 nm (PE59) | 0.5% | 92.4 | 0.43 | 91.2 | 3.86 | −1.2 | 3.43 |
| 47 | 5 nm (PE60) | 1.5% | 92.6 | 0.42 | 91.4 | 3.45 | −1.2 | 3.03 |
| 48 | 5 nm (PE61) | 3.0% | 92.4 | 0.40 | 91.3 | 2.43 | −1.1 | 2.03 |
| 49 | 5 nm (PE62) | 5.0% | 92.3 | 0.42 | 91.3 | 2.52 | −1.0 | 2.10 |
| 50 | 5 nm (PE63) | 7.5% | 92.3 | 0.42 | 91.4 | 2.34 | −0.9 | 1.92 |

The initial transmission and haze of Examples 46-50 and CE39 were measured with a BYK HAZE GARD I instrument (BYK Instruments, Geretsried, Germany). The results are shown in the table above. The examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

TABLE 33
Hardcoat Testing, Linear Taber Abrasion

| | | Nano- | | | | | | |
|---|---|---|---|---|---|---|---|---|
| | | particle | | | | | | |
| | | Concentration | Average | Average | Average | Average | | |
| | Nano-particle | in Transfer | Initial | Initial | Final | Final | Delta | Delta |
| Example | Layer | Layer | Transmission | Haze | Transmission | Haze | Transmission | Haze |
| CE39 | None | N/A | 92.2 | 0.45 | 90.9 | 15.4 | −1.3 | 15.0 |
| 46 | 5 nm (PE59) | 0.5% | 92.4 | 0.43 | 90.7 | 17.2 | −1.7 | 16.8 |
| 47 | 5 nm (PE60) | 1.5% | 92.6 | 0.42 | 90.9 | 14.5 | −1.7 | 14.1 |
| 48 | 5 nm (PE61) | 3.0% | 92.4 | 0.40 | 91.8 | 7.32 | −0.6 | 6.92 |
| 49 | 5 nm (PE62) | 5.0% | 92.3 | 0.42 | 91.8 | 5.02 | −0.5 | 4.60 |
| 50 | 5 nm (PE63) | 7.5% | 92.3 | 0.42 | 92.2 | 2.60 | −0.1 | 2.18 |

The initial transmission and haze of Examples 46-50 and CE39 were measured with a BYK HAZE GARD I instrument (BYK Instruments, Geretsried, Germany). The results are shown in the table above. The examples were tested for abrasion resistance according to ASTM D6279-15. Two specimens for each condition were tested and the results averaged. SCOTCH-BRITE 07448 abrasive pad (available from 3M), 40 cycles, 750 gram load, 3 in (7.6 cm) stroke length, 60 cycles/min. The post-abrasion (final) haze and transmission were measured on the same instrument.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the present disclosure.

1. A coating composition comprising:
a nanoparticle layer comprising nanoparticles and a curable resin; and
a curable resin layer comprising the curable resin,
wherein the nanoparticle layer has a thickness of 0.2 μm to 8 μm, and wherein the nanoparticle layer comprises less than 40 vol. % of the curable resin.

2. The coating composition of claim 1, wherein the nanoparticle layer has a thickness of 0.4 μm to 6 μm, optionally 0.8 μm to 4 μm, or optionally 1 μm to 3 μm.

3. The coating composition of claim 1, wherein the nanoparticle layer comprises less than 30 vol. %, less than 20 vol. %, less than 10 vol. %, less than 5 vol. %, or less than 1 vol. % of the curable resin.

4. The coating composition of claim 1, wherein the nanoparticles comprise silica, alumina, ceria, diamond, titanium dioxide, zinc oxide, tungsten oxide, zirconia, calcium carbonate, magnesium silicate, indium tin oxide, antimony tin oxide, tungsten bronze, and combinations thereof.

5. The coating composition of claim 4, wherein the nanoparticles have average diameters of from 1 nm to 400 nm, optionally 2 nm to 200 nm, or optionally 5 nm to 100 nm.

6. The coating composition of claim 1, wherein the nanoparticles have an aspect ratio of 2:1 to 12:1, optionally 3:1 to 11:1, optionally 4:1 to 10:1, optionally 5:1 to 9:1.

7. The coating composition of claim 1, wherein the nanoparticles comprise an elongated silica nanoparticle having a diameter of 9 nm to 15 nm and a length of 40 nm to 100 nm.

8. The coating composition of claim 1, wherein the nanoparticles comprise a silane coating.

9. The coating composition of claim 1, wherein the curable resin comprises a (meth)acrylate resin, a polyurethane precursor, an epoxy precursor, a polyurea precursor, a cyanoacrylate resin, a polyester (meth)acrylate resin, a polyurethane (meth)acrylate resin, and combinations thereof.

10. The coating composition of claim 1, wherein the curable resin comprises a (meth)acrylate resin.

11. The coating composition of claim 10, wherein the (meth)acrylate resin comprises at least one (meth)acrylate component having a functionality of two or higher.

12. The coating composition of claim 1, wherein the curable resin further comprises wt. % to 60 wt. %, 0.1 wt. % to 20 wt. %, or 0.1 wt. % to 10 wt of a nanoparticle dispersed throughout the curable resin bulk.

13. The coating composition of claim 1, wherein the curable resin is free of dispersed nanoparticles.

14. The coating composition of claim 1, wherein the curable resin further comprises 0.1 wt. % to 10 wt. % of a photoinitiator.

15. The coating composition of claim 1, wherein the curable resin further comprises an additive selected from the group consisting of a pigment, an antioxidant, a surfactant, a solvent, a wetting aid, a slip agent, a leveling agent, and combinations thereof.

16. A hardcoat prepared using the coating composition of claim 1.

17. The hardcoat of claim 13, wherein the hardcoat has a delta haze % less than 25, less than 10, less than 5, less than 2.5, or less than 2 according to ASTM D1044-13.

18. A laminate comprising:
the coating composition of claim 1; and
a substrate,
wherein the substrate is adjacent the curable resin layer.

19-22. (canceled)

23. A method of coating a substrate, the method comprising:
preparing the coating composition of claim 1; and
applying the coating composition to a substrate
wherein the substrate is adjacent the curable resin layer.

24. The method of claim 23, further comprising exposing the substrate to actinic radiation.
